(19) United States
(12) Patent Application Publication
(10) Pub. No.: US 2026/0016376 A1
(43) Pub. Date: Jan. 15, 2026

(54) RAPID IN-SITU STRATIFIED COLLECTION DEVICE AND METHOD FOR SEDIMENT POLLUTION IN RIVERS AND LAKES

(71) Applicant: Changjiang River Scientific Research Institute, Wuhan City (CN)

(72) Inventors: Zhenhua WANG, Wuhan City (CN); Yanping HU, Wuhan City (CN); Xianqiang TANG, Wuhan City (CN); Rui LI, Wuhan City (CN); Meng LONG, Wuhan City (CN); Kezheng SONG, Wuhan City, Hubei (CN); Wenliang ZHAI, Wuhan City, Hubei (CN)

(21) Appl. No.: 19/019,612

(22) Filed: Jan. 14, 2025

(30) Foreign Application Priority Data
Jul. 12, 2024 (CN) 202410935887.7

(51) Int. Cl. G01N 1/14; G01N 1/10

(52) U.S. Cl. CPC G01N 1/14; G01N 2001/1025; G01N 2001/1418

(57) ABSTRACT

Provided are a rapid in-situ stratified collection device and method for sediment pollution in rivers and lakes. The device includes a main control system, a main collection system, a fixing frame, a bathymetric module, a working hull, and a crane. The bathymetric module is installed below the working hull, the main control system and the crane are both installed on the working hull, the main collection system is fixed in the fixing frame and connected to the crane. The bathymetric module is used to detect and determine a water depth, and thicknesses of sediment. The main control system is used to control a collection process of the main collection system, read the water depth and a thickness of the sediment in real time, and determine whether the main collection system is completely inserted into the sediment. The main collection system is used for stratified collection of sediment pore solution.

### CROSS-REFERENCE TO RELATED APPLICATION

This patent application claims the benefit and priority of Chinese Patent Application No. 202410935887.7, filed with the China National Intellectual Property Administration on Jul. 12, 2024, the disclosure of which is incorporated by reference herein in its entirety as part of the present application.

### TECHNICAL FIELD

The present disclosure relates to the technical field of the monitoring of sediment pollution in rivers and lakes, and in particular to a rapid in-situ stratified collection device and method for sediment pollution in rivers and lakes.

### BACKGROUND

After the exogenous pollution input of rivers and lakes is effectively controlled, the sampling and analysis of sediment pollution (that is, endogenous pollution) is an important foundation and prerequisite for the ecological protection and restoration of rivers and lakes in the future. At present, in China and at abroad, the sediment in rivers and lakes is mainly collected by grab sampler or columnar sampler, and the content of various speciation of sediment pollutants is analyzed by a continuous extraction method to reveal the characteristics of endogenous pollution and its release risk. However, there are the following shortcomings in practical application or scientific research: (1) For fluid mud and flow mud, the grab sampler is great in disturbance, low in sampling rate, and incapability of carrying out stratified sampling; (2) for fluid mud and flow mud, a columnar sample collected by the columnar sampler is easy to deform, and the stratified mud sample is deviated from the actual situation; and (3) the collected mud samples need to undergo complicated procedures such as air drying, sample preparation, extraction, computer testing, etc., leading to low efficiency of sampling and testing, and large error of detection result.

There have been studies showing that sediment pore water is an important occurrence medium and release source of pollutants, and the concentration of pollutants in the sediment pore solution is positively correlated with the release flux of sediment pollution. That is, the characteristics of the sediment pollution can be quickly and accurately acquired through in-situ collection of sediment pore solution samples and analysis of the content of pollutants in the sediment pore solution, thus predicting and evaluating the risk of release of the sediment pollution.

### SUMMARY

In order to overcome the disadvantages in the prior art, an objective of the present disclosure is to provide rapid in-situ stratified collection device and method for sediment pollution in rivers and lakes. The problems that the sampling rate is low, the stratified sampling cannot be carried out, a layered mud sample is deviated from an actual situation, the efficiency is low and a detection result is large in error in the prior art can be solved.

To achieve the objective above, the present disclosure provides the following technical solution.

A rapid in-situ stratified collection device for sediment pollution in rivers and lakes includes a main control system, a main collection system, a fixing frame, a bathymetric module, a working hull, and a crane.

The bathymetric module is installed below a stern of the working hull, the main control system and the crane are both installed on the working hull, the crane is connected to the fixing frame, and the main collection system is connected to four corners at an upper end of the fixing frame by haulage ropes.

The bathymetric module is used to determine a water depth, and thicknesses of fluid mud, flow mud and silt; the main control system is used to control a collection process of the main collection system, read the water depth and a thickness of a sediment in real time, and determine whether the main collection system is completely inserted into the sediment or not; and the main collection system is inserted into the sediment for the collection of a sediment pore solution.

Alternatively, the main collection system further includes a sediment pore solution collection module, a mud-water interface positioning module, a high-frequency vibration hammering module, an exhaust-water guide pipe, a support platform, a filtration membrane tube, and an overlying water isolation plate.

The sediment pore solution collection module is installed below the overlying water isolation plate. The mud-water interface positioning module is installed at a lower end of the support platform. The support platform is arranged above the overlying water isolation plate, the high-frequency vibration hammering module is installed at an upper end of the support platform and connected to the crane through an electric cable, and connected to the fixing frame through four haulage ropes. The filtration membrane tube is arranged in the sediment pore solution collection module.

The sediment pore solution collection module is used to collect the sediment pore solution in a stratified manner. The mud-water interface positioning module is used to collect turbidity of a mud-water interface. The overlying water isolation plate is used to prevent overlying water from invading the sediment pore solution collection module. The high-frequency vibration hammering module is used to send out downward vibration hammering to insert the sediment pore solution collection module into the sediment. The filtration membrane tube is used to collect the sediment pore solution in a stratified manner. The support platform is used to support and fix the high-frequency vibration hammering module.

Alternatively, the main control system further includes a vacuum negative pressure module, a pore solution extraction module, and a data read module.

The vacuum negative pressure module and the pore solution extraction module are connected to the sediment pore solution collection module through the exhaust-water guide pipe in an electrical cable by the crane. The data read module is connected to the bathymetric module and the mud-water interface positioning module through electric cables, respectively.

The vacuum negative pressure module is used to vacuumize the filtration membrane tube. The pore solution extraction module is used to acquire the sediment pore solution in the filtration membrane tube. The data read module is used to read the water depth and the thickness of the sediment in real time, and determine whether the main collection system is completely inserted into the sediment or not.

Preferably, six to eight groups of filtration membrane tubes are provided, which are vertically arranged at different parts in the corresponding sediment pore solution collection module in sequence in a stratified manner, and a vertical spacing between the two adjacent groups of filtration membrane tubes is 10 cm.

Preferably, the overlying water isolation plate is covered with trapezoidal holes.

A rapid in-situ stratified collection method for sediment pollution in rivers and lakes includes determining a water depth, and thicknesses of fluid mud, flow mud and silt; and according to the water depth and the thicknesses of the fluid mud, the flow mud and the silt, accurately inserting a main collection system into a sediment through a main control system to achieve stratified collection of a sediment pore solution.

The present disclosure has the following technical effects.

The present disclosure provides a rapid in-situ stratified collection device for sediment pollution in rivers and lakes, including a main control system, a main collection system, a fixing frame, a bathymetric module, a working hull, and a crane. The bathymetric module is installed below a stern of the working hull, the main control system and the crane are both installed on the working hull, the main collection system is connected to the crane, and the main collection system is fixed in the fixing frame. The bathymetric module is used to detect and determine a water depth, and thicknesses of fluid mud, flow mud and silt. The main control system is used to control a collection process of the main collection system, read the water depth and a thickness of the sediment in real time, and determine whether the main collection system is completely inserted into the sediment or not. The main collection system is inserted into the sediment for stratified collection of a sediment pore solution. Whether it is the fluid mud, flow mud or silt, the low-disturbance and rapid in-situ stratified collection of the sediment pore solution can be achieved, and the device has strong device applicability, and the collected sediment pore solution can be directly tested on a computer. By collecting a sediment pore solution sample and testing the concentration of pollutants therein, the risk of release of the sediment pollution can be directly predicted and evaluated, which can save the tedious procedures such as air drying, sample preparation and extraction needed in the traditional analysis process of the content of speciation of the sediment pollutants, greatly shorten the sampling time of the sediment pollution sample from 10-15 days to 1-2 days, and improve the sampling efficiency by more than 90%. The device can collect pore solution of the sediment pore solution in rivers and lakes under special circumstances, ensure the safety of scientific researcher, and has broad application prospects.

### BRIEF DESCRIPTION OF THE DRAWINGS

To describe the technical solutions of the embodiments of the present disclosure Embodiment: or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an overall rapid in-situ stratified collection device for sediment pollution in rivers and lakes according to an embodiment of the present disclosure;

FIG. 2 is a front view of a main collection system according to an embodiment of the present disclosure;

FIG. 3 is a schematic structural diagram of a main collection system according to an embodiment of the present disclosure.

The reference numerals are as follows:
1—main control system; 2—crane, 3—main collection system; 4—fixing frame; 5—bathymetric module; 6—electric cable; 7—haulage rope; 8—overlying water isolation plate; 9—filtration membrane tube; 10—high-frequency vibration hammering module; 11—exhaust-water guide pipe; 12—support platform; 13—mud-water interface positioning module; 14—sediment pore solution collection module.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

In order to make the objectives, features and advantages of the present disclosure more clearly, the present disclosure is further described in detail below with reference to the accompanying drawings and specific embodiments.

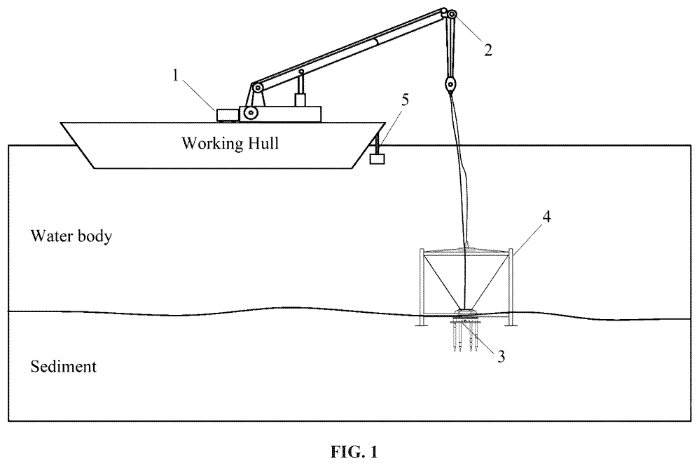

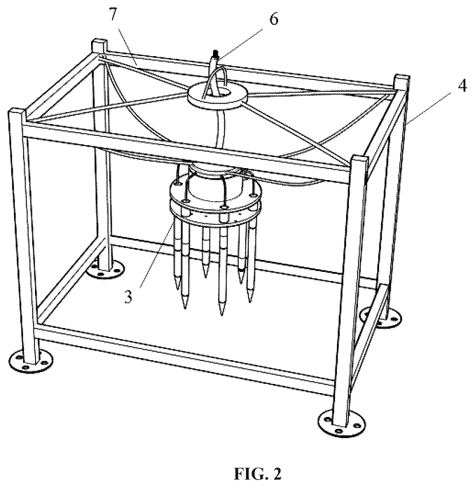

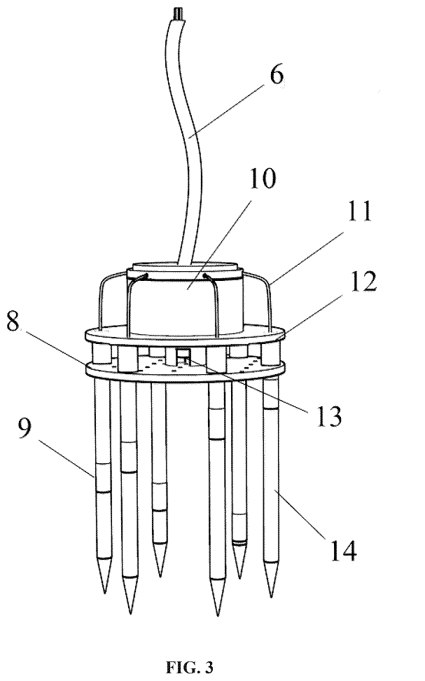

As shown in FIG. 1 to FIG. 3, a rapid in-situ stratified collection device for sediment pollution in rivers and lakes includes:
a main control system 1, a main collection system 3, a fixing frame 4, a bathymetric module 5, a working hull, and a crane 2.

The bathymetric module 5 is installed below a stern of the working hull, the main control system 1 and the crane 2 are both installed on the working hull, the crane 2 is connected to the fixing frame 4, and the main collection system 3 is connected to four corners at an upper end of the fixing frame 4 by haulage ropes 7.

The bathymetric module 5 is used to determine a water depth, and thicknesses of fluid mud, flow mud and silt. The main control system 1 is used to control a collection process of the main collection system 3, read the water depth and a thickness of a sediment in real time, and determine whether the main collection system 3 is completely inserted into the sediment or not. The main collection system is inserted into the sediment for the collection of a sediment pore solution.

Further, the main collection system 3 further includes:
a sediment pore solution collection module 14, a mud-water interface positioning module 13, a high-frequency vibration hammering module 10, an exhaust-water guide pipe, a support platform 12, a filtration membrane tube 9, and an overlying water isolation plate 8.

The sediment pore solution collection module 14 is installed below the overlying water isolation plate 8. The mud-water interface positioning module 13 is installed at a lower end of the support platform 12. The support platform 12 is arranged above the overlying water isolation plate 8. The high-frequency vibration hammering module 10 is installed at an upper end of the support platform 12 and connected to the crane 2 through an electric cable 6, and connected to the fixing frame 4 through four haulage ropes 7. The filtration membrane tube 9 is arranged in the sediment pore solution collection module 14.

The sediment pore solution collection module 14 is used to collect the sediment pore solution in a stratified manner. The mud-water interface positioning module 13 is used to collect turbidity of a mud-water interface. The overlying water isolation plate 8 is used to prevent overlying water from invading the sediment pore solution collection module 14. The high-frequency vibration hammering module 10 is used to send out downward vibration hammering to insert the sediment pore solution collection module 14 into the sediment. The filtration membrane tube 9 is used to collect the sediment pore solution in a stratified manner. The support platform 12 is used to support and fix the high-frequency vibration hammering module 10.

Specifically, the bathymetric module 5 and the mud-water interface positioning module 13 are connected to the data read module of the main control system 1 through an electric cable 6, and can be used to read the water depth, the thicknesses of the fluid mud, flow mud and silt, and turbidity of a mud-water interface in real time.

Further, the main control system 1 further includes:
a vacuum negative pressure module, a pore solution extraction module, and a data read module.

The vacuum negative pressure module and the pore solution extraction module are connected to the sediment pore solution collection module 14 through the exhaust-water guide pipe 6 in an electrical cable by the crane. The data read module is connected to the bathymetric module 5 and the mud-water interface positioning module 13 through electric cables 6, respectively.

The vacuum negative pressure module is used to vacuumize the filtration membrane tube. The pore solution extraction module is used to acquire the sediment pore solution in the filtration membrane tube. The data read module is used to read the water depth and the thickness of the sediment in real time, and determine whether the main collection system 3 is completely inserted into the sediment or not.

Specifically, the vacuum negative pressure module is used to provide a negative pressure for a cavity in the filtration membrane tube in the sediment pore solution collection module 14, thus promoting the collection of the sediment pore solution.

The pore solution extraction module is similar to a peristaltic pump, and is used to extract and temporarily store a pore solution collected in the filtration membrane tube. The extracted pore solution is used for test and analysis.

The data read module is similar to a control panel, which can be used to read and store the data such as the water depth, the mud depth, the turbidity of the mud-water interface, and a scaling length of the haulage rope 7.

Specifically, the bathymetric module 5 is used to determine the water depth, the thicknesses of the fluid mud, flow mud and silt, thus determining a length specification of the sediment pore solution collection module 14. The mud-water interface positioning module 13, the crane 2 and the high-frequency vibration hammering module 10 are used to insert the sediment pore solution collection module 14 into the sediment completely and accurately. Through the negative pressure extraction of the vacuum negative pressure module and the pore solution extraction module in the main control system 1, the pore solution collection module 14 in the main collection system 3 can achieve the in-situ stratified collection of the sediment pore solution.

The sludge can be divided into fluid mud, flow mud, silt and muddy soil according to water content, porosity, density, etc. From top to bottom, it is generally a fluid mud layer, a flow mud layer, a silt layer, and a muddy soil layer. The pollutant is stable and not easy to release due to the small porosity of the bottom muddy soil. The thickness of fluid mud+flow mud+silt with higher risk of pollutant release in the upper layer of the bottom muddy soil needs to be determined by the bathymetric module 5, and the length specification of the detachable filtration membrane tube 9 is provided in a matched manner according to the thickness of fluid mud+flow mud+silt. An approximate length of the haulage rope 7 is determined according to the length of the water depth+the length of the detachable filtration membrane tube 9. The device is put into a water body by the crane 2 to reach the mud-water interface, and then is inserted into the sediment by the high-frequency vibration hammering module 10.

More specifically, the sludge can be divided into fluid mud, flow mud, silt and muddy soil according to water content, porosity, density, etc. From top to bottom, it is generally a fluid mud layer, a flow mud layer, a silt layer, and a muddy soil layer. The pollutant is stable and not easy to release due to the small porosity of the bottom muddy soil. The thickness of fluid mud+flow mud+silt with higher risk of pollutant release in the upper layer of the bottom muddy soil needs to be determined by the bathymetric module 5, and the length specification of the detachable filtration membrane tube 9 is provided in a matched manner according to the thickness of fluid mud+flow mud+silt. An approximate length of the haulage rope 7 is determined according to the length of the water depth+the length of the detachable filtration membrane tube 9. The device is put into a water body by the crane 2 to reach the mud-water interface, and then is inserted into the sediment by the high-frequency vibration hammering module. The turbidity change is monitored in real time according to the mud-water interface positioning module 13 to determine whether to insert the device into the sediment accurately. Six groups of filtration membrane tubes 9 can be simultaneously provided, and have different depths, such that the collected liquid in different groups of filtration membrane tubes 9 can be extracted through the vacuum negative pressure module and the pore solution extraction module, thus achieving stratified, in-situ and rapid collection of the sediment pore solution.

Further, six groups of filtration membrane tubes 9 are provided, which are vertically arranged at different parts in the corresponding sediment pore solution collection module 14 in sequence in a stratified manner, and a vertical spacing between the two adjacent groups of filtration membrane tubes 9 is 10 cm. specifically, the filtration membrane tubes 9 are arranged at 0-10 cm, 10-20 cm, 20-30 cm, 30-40 cm, 40-50 cm and 50-60 cm of different sediment pore solution collection modules 14.

Specifically, through different installation positions of filtration membrane tubes 9, the depths of the sediment pore solution collected by various groups is different, and the sampling processes between the groups are independent and do not interfere with each other. Therefore, the stratified and in-situ collection can be achieved.

Further, the overlying water isolation plate 8 is covered with trapezoidal holes.

Specifically, the overlying water isolation plate 8 is porous, the hole is a “trapezoidal hole” with a big bottom and a small top. After the overlying water isolation plate 8 is submerged in the water, the sediment can reach the mud-water interface positioning module 13 after passing through the “trapezoidal hole”, which makes the turbidity measured by the mud-water interface positioning module 13 rise sharply, thus determining that the device is accurately inserted into the sediment. (Before the device is inserted into the sediment, the turbidity of the water body is mainly measured, which is small and relatively stable, and after the device is inserted into the sediment, the value is large and sharply increases).

A boss is arranged above the high-frequency vibration hammering module 10, and six to eight holes are formed in a side plate of the boss for the exhaust-water guide pipe to penetrate. Six to eight groups of hollow connectors are arranged below the support platform 12, and used to fix the overlaying water isolation plate 8 and the sediment pore solution collection module 14. The exhaust-water guide pipe 11 is led out from the filtration membrane tube, passes through the hollow connector and the boss of the support platform 12, then is integrated into the electrical cable 6 with an electric wire, and is connected to the main control system 1 through a pulley. The high-frequency vibration hammer module 10 is connected to four corners of the fixing frame 4 through four haulage ropes 7.

This embodiment further provides a rapid in-situ stratified collection device for sediment pollution in rivers and lakes, including the following steps:
determining a water depth, and thicknesses of fluid mud, flow mud and silt by a bathymetric module 5; and
according to the water depth and the thicknesses of the fluid mud, the flow mud and the silt, accurately inserting a main collection system 3 into a sediment through a traction module, high-frequency vibration hammering and with the cooperation of a mud-water interface positioning module 13.

Specifically, through the negative pressure extraction of the vacuum negative pressure module and the pore solution extraction module in the main control system 1, the pore solution collection module 14 in the main collection system 3 can achieve rapid in-situ stratified collection of the sediment pore solution, and the concentration of pollutants in the sediment pore solution can be directly tested on the computer.

Various embodiments in this specification are described in a progressive way, and each embodiment focuses on the differences from other embodiments, so it is only necessary to refer to the same and similar parts between each embodiment.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A rapid in-situ stratified collection device for sediment pollution in rivers and lakes, comprising:
a main control system;
a main collection system inserted into the sediment for the collection of a sediment pore solution, the main control system controls a collection process of the main collection system, reads the water depth and a thickness of a sediment in real time, and determines whether the main collection system is completely inserted into the sediment or not;
a fixing frame, the main collection system being connected to four corners at an upper end of the fixing frame by haulage ropes;
a bathymetric module for determining a water depth, and thicknesses of fluid mud, flow mud and silt;
a working hull, the bathymetric module being installed below a stern of the working hull; and
a crane connected to the fixing frame, the main control system and the crane being both installed on the working hull.

2. The rapid in-situ stratified collection device for sediment pollution in rivers and lakes according to claim 1, wherein the main collection system comprises:
a sediment pore solution collection module collects the sediment pore solution in a stratified manner;
a mud-water interface positioning module collects turbidity of a mud-water interface;
a high-frequency vibration hammering module sends out downward vibration hammering to insert the sediment pore solution collection module into the sediment;
an exhaust-water guide pipe;
a support platform supports and fixes the high-frequency vibration hammering module, the mud-water interface positioning module being installed at a lower end of the support platform, the high-frequency vibration hammering module being installed at an upper end of the support platform and connected to the crane through an electric cable, and connected to the fixing frame through four haulage ropes;
a filtration membrane tube arranged in the sediment pore solution collection module collects the sediment pore solution in a stratified manner; and
an overlying water isolation plate prevents overlying water from invading the sediment pore solution collection module, the sediment pore solution collection module being installed below the overlying water isolation plate and the support platform is arranged above the overlying water isolation plate.

3. The rapid in-situ stratified collection device for sediment pollution in rivers and lakes according to claim 2, wherein the main control system comprises:
a vacuum negative pressure module vacuumizes the filtration membrane tube;
a pore solution extraction module acquires the sediment pore solution in the filtration membrane tube, the vacuum negative pressure module and the pore solution extraction module being connected to the sediment pore solution collection module through the exhaust-water guide pipe in an electrical cable by the crane; and
a data read module connected to the bathymetric module and the mud-water interface positioning module through electric cables, respectively, the data read module reads the water depth and the thickness of the sediment in real time and determines whether the main collection system is completely inserted into the sediment or not.

4. The rapid in-situ stratified collection device for sediment pollution in rivers and lakes according to claim 2, wherein six to eight groups of filtration membrane tubes are provided, which are vertically arranged at different parts in the corresponding sediment pore solution collection module in sequence in a stratified manner, and a vertical spacing between the two adjacent groups of filtration membrane tubes is 10 cm.

5. The rapid in-situ stratified collection device for sediment pollution in rivers and lakes according to claim 2, wherein the overlying water isolation plate is covered with trapezoidal holes.

6. A rapid in-situ stratified collection method for sediment pollution in rivers and lakes, comprising:
determining a water depth, and thicknesses of fluid mud, flow mud and silt; and
according to the water depth and the thicknesses of the fluid mud, the flow mud and the silt, accurately inserting a main collection system into a sediment through a main control system to achieve stratified collection of a sediment pore solution.
